(19) United States
(12) Patent Application Publication
(10) Pub. No.: US 2013/0060547 A1
(43) Pub. Date: Mar. 7, 2013

(54) VISUALIZATION SYSTEM FOR MULTIDIMENSIONAL SPACE OF PARTITIONS

(71) Applicants: Jaroslav Beran, Prague (CZ); Jiri Findejs, Prague (CZ)

(72) Inventors: Jaroslav Beran, Prague (CZ); Jiri Findejs, Prague (CZ)

(73) Assignee: HONEYWELL SPOL, S.R.O., Prague (CZ)

(21) Appl. No.: 13/224,209

(22) Filed: Sep. 1, 2011

(51) Int. Cl. G06F 17/50

(52) U.S. Cl. 703/7

(57) ABSTRACT

A system for user interactive visualization of multidimensional space of geometrical shaped partitions. An engine model with operating points may be implemented. A controller may provide tuning for each operating point. Space of the operating points may define a multidimensional matrix, where a number of dimensions is similar to a number of scheduled variables for the engine. Each dimension may be divided into scheduled variable intervals. Multidimensional rectangular partitions may be created from one or more combinations of the intervals. A user may interactively select one or more of the partitions and specify tuning parameters for them. A display may provide graphical feedback about the tuning state or controller behavior about the partitions. The display may also provide a user-selected two-dimensional subspace. The dimensions, i.e., scheduled variables, of the selected subspace and their order may be specified by the user. Additional dimensions of the selected subspace may be presented.

### BACKGROUND

The present disclosure pertains to engines, and particularly to operating points of engines. More particularly, the disclosure pertains to a visualization of the operating points.

### SUMMARY

The disclosure reveals a system for user interactive visualization of multidimensional space of rectangular partitions. An engine may have operating points. A model of the engine may be implemented. A controller may provide tuning for each of the operating points. Space of the operating points may define a multidimensional matrix, where a number of dimensions is similar to a number of scheduled variables for the engine. Each dimension may be divided into scheduled variable intervals. Multidimensional rectangular partitions may be created from one or more combinations of the intervals. A user may interactively select one or more of the partitions and specify tuning parameters for them. A display may provide graphical feedback about the tuning state or controller behavior about the partitions. The display may also provide a user-selected two-dimensional subspace. The dimensions, i.e., scheduled variables, of the selected subspace and their order may be specified by the user. Additional dimensions of the selected subspace may be presented on the display, for showing a size and position of the selected subspace inside a whole space. Each partition may be displayed as a rectangular cell. A partition may have properties for partition selection related to other user interface elements and presentation on a display of an abbreviated partition state. Also, each selected cell may have a tooltip for presenting on the display extended information about the partition or selected subspace.

### BRIEF DESCRIPTION OF THE DRAWING

FIG. 1 is a diagram of a system for providing a user interactive visualization;

FIGS. 2a-2d are diagrams which illustrate an example of a multi-dimensional space visualization;

FIG. 3 is a diagram of a controller configuration which is a basic screen for controller design;

FIG. 4 is a diagram of an operating point screen which may allow editing of coordinates of virtually all scheduled variables;

FIG. 5 is a diagram which shows feedforward tuning;

FIG. 6 is a diagram which shows feedback tuning;

FIG. 7 is a diagram revealing an example of feedback advanced tuning for a controller;

FIG. 8a is a diagram of a horizontal version of an operating point selector for an operating point;

FIG. 8b is a diagram of a horizontal version of an operating point selector for variables;

FIG. 9a is a diagram of a vertical version of an operating point selector for an operating point; and

FIG. 9b is a diagram of a vertical version of an operating point selector for variables.

### DESCRIPTION

The present approach may be used in an off-line tool. The tool may work with data measured on AN engine (e.g., actuators' positions and sensors' values), but it does not necessarily read/write any value directly from/to an engine. The output of the tool may be a tuned controller in a form of source files in C programming language. The source files may then be compiled and uploaded to an engine control unit, which controls the engine in real-time. The compilation and upload may be done by an engineer not using the present tool.

There appears to be a need of a user interactive visualization of multidimensional space of rectangular partitions. An engine controller may provide a different tuning for each of an engine's operating points. The space of operating points may define a multidimensional matrix, where a number of dimensions may be the number or similar to the number of scheduled variables (e.g., engine speed, fuel, start of injection, ambient temperature, or even user-defined ones such as engine mode, and so forth).

Each dimension may be divided into a set of scheduled variable intervals. A combination of these intervals may create multidimensional rectangular partitions. The number of scheduled variables and the number of intervals may be varied, as defined by a user.

The user may have to interactively select one or more partitions and specify the tuning parameters. A user interface (UI) should provide a graphical feedback about a partitions' tuning state or controller behavior.

The present approach may display a user-selected two-dimensional subspace. Dimensions for a selected sub-space and the order of virtually all of the dimensions (i.e., scheduled variables) may be specified by user. A third dimension and additional dimensions of the selected sub-space may be displayed on auxiliary UI elements, so that the user can easily see the size and position of a selected subspace inside the whole space.

Each partition may be displayed as a rectangular cell. A partition may have a color, draw a text and can be pressed. These properties may be used for: 1) partition selection related to other UI elements (e.g., tuning parameters, specification, trend lines, and so on); and 2) displaying an abbreviated partition state (e.g., tuning type, a modified or valid flag, and so on).

Additionally, each UI selected cell may have a tooltip for displaying extended information about the partition or selected subspace.

The present approach may currently be used in an advanced control technology design suite tool, where controller parameters may be scheduled by more than two external signals (i.e., scheduled variables).

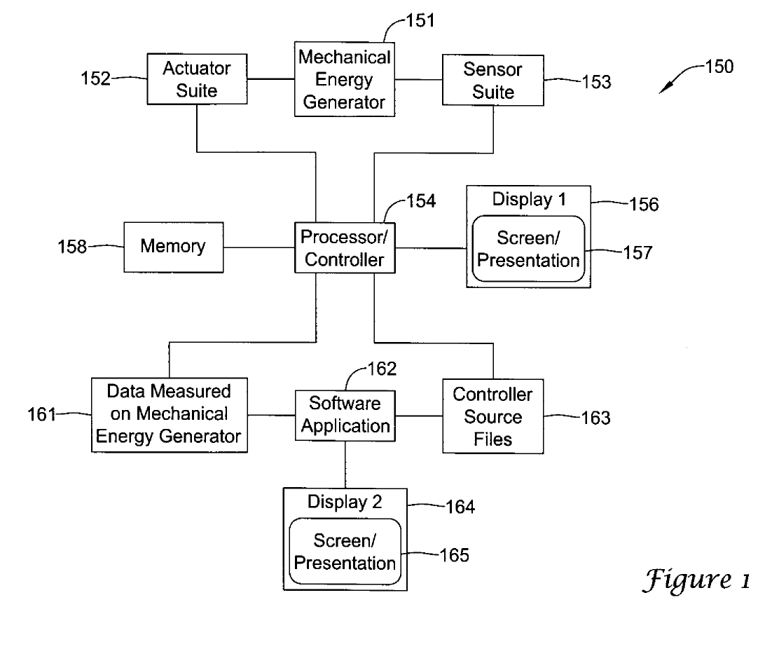

FIG. 1 is a diagram of a system 150 for providing a user interactive visualization. A subject of the visualization may be a mechanical energy generator 151 such as an internal combustion engine (e.g., a diesel with a turbocharger). Generator 151 may be a simulation or a model. Generator may hereafter be referred to engine 151. There may be an actuator suite 152 associated with engine 151, such as for controlling an intake throttle, VGT vanes, start of injection, EGR mode, injection quantity, and so on. There may be a sensor suite 153 associated with engine 151, such as for detecting rpm, turbocharger speed, boost pressure, engine temperature, and so on. Actuator suite 152 and sensor suite 153 may be connected to a controller or processor 154. A display 156 may be connected to controller 154. Display 156 may provide a screen, presentation or visualization 157 of such items as, for instance, an interactive visualization of a multidimensional space of rectangular partitions. Display 156 may be used, at least in part, as the user interface. A memory 158 may be connected to controller or processor 154. Memory 158 may contain data, algorithms, information, and other items as needed for effecting the present system.

A block 161 may be connected to controller 154. Block 161 may indicate data measured on the engine. There may be one or more files containing data measured on the engine (i.e., both actuator positions and sensor values) and recoded by controller 154. A block 162, representing a software application, may be connected to the data measured on engine block 161. The software application may be the one being developed. It may be a tool-like application, which allows one to create an engine model and design, and tune the controller for the engine. A block 163, connected to controller 154 and software application block 162, represents controller source files (i.e., set of C-code files), which may be executable by controller 154 and may control engine 151. An engineer may need to compile the C source code and upload the files to controller 154. Connected to software application block 162 may be a display 164 to provide a screen, presentation or visualization 165 as an application graphical user interface.

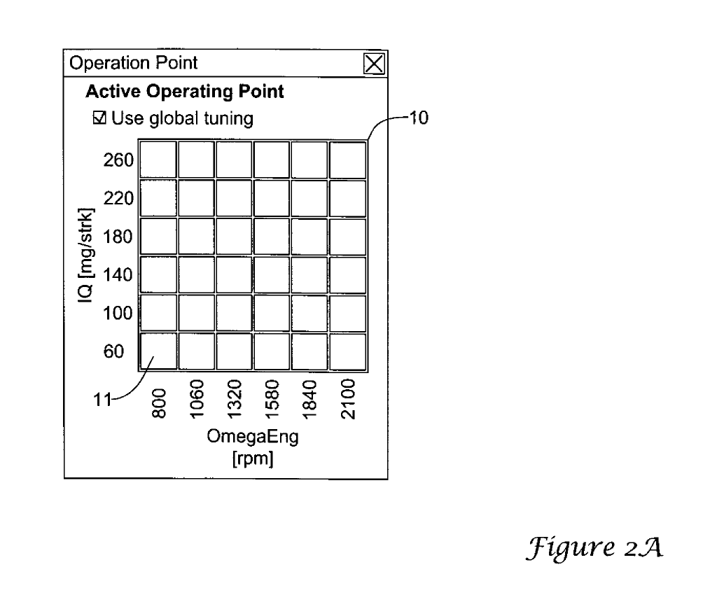

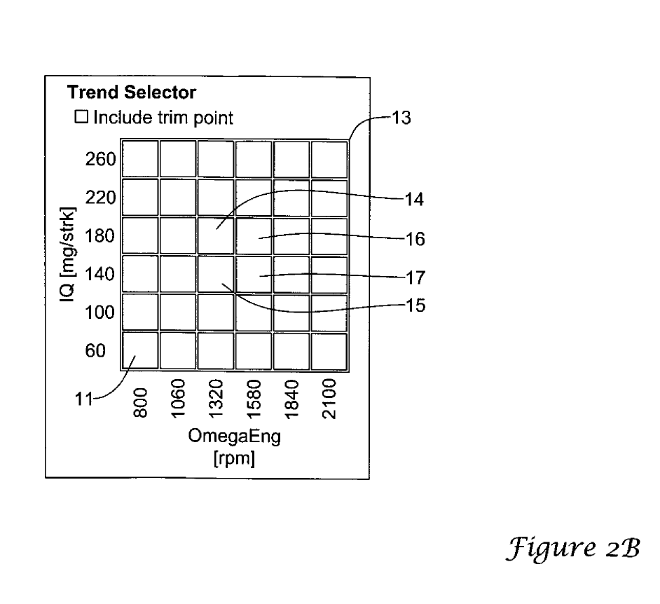

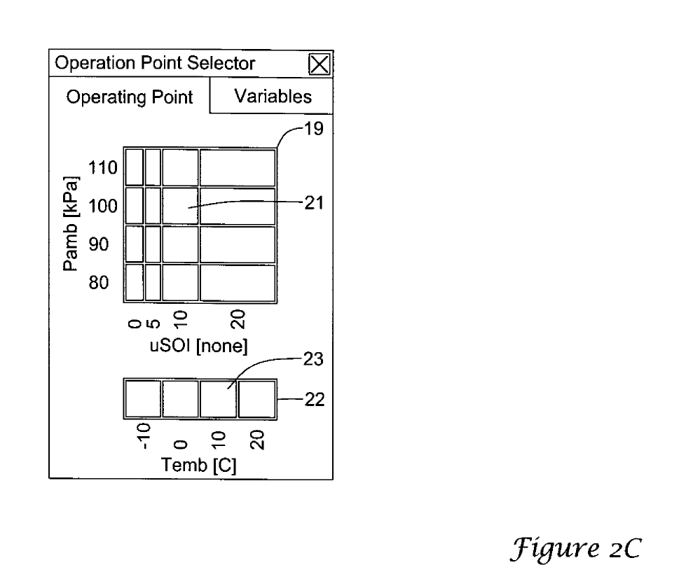

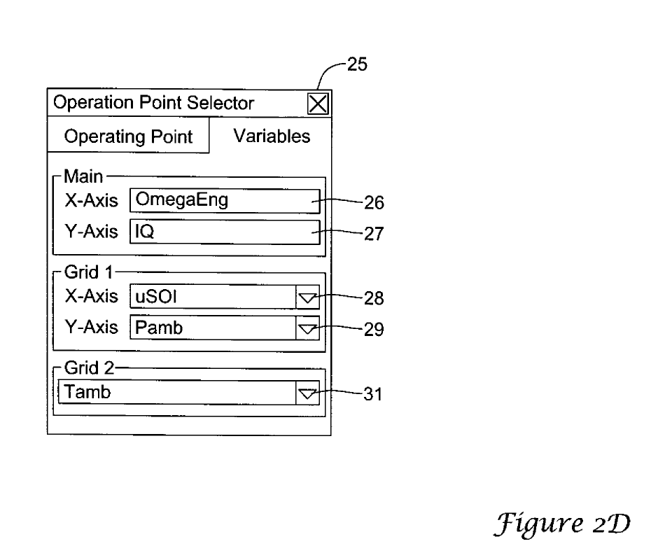

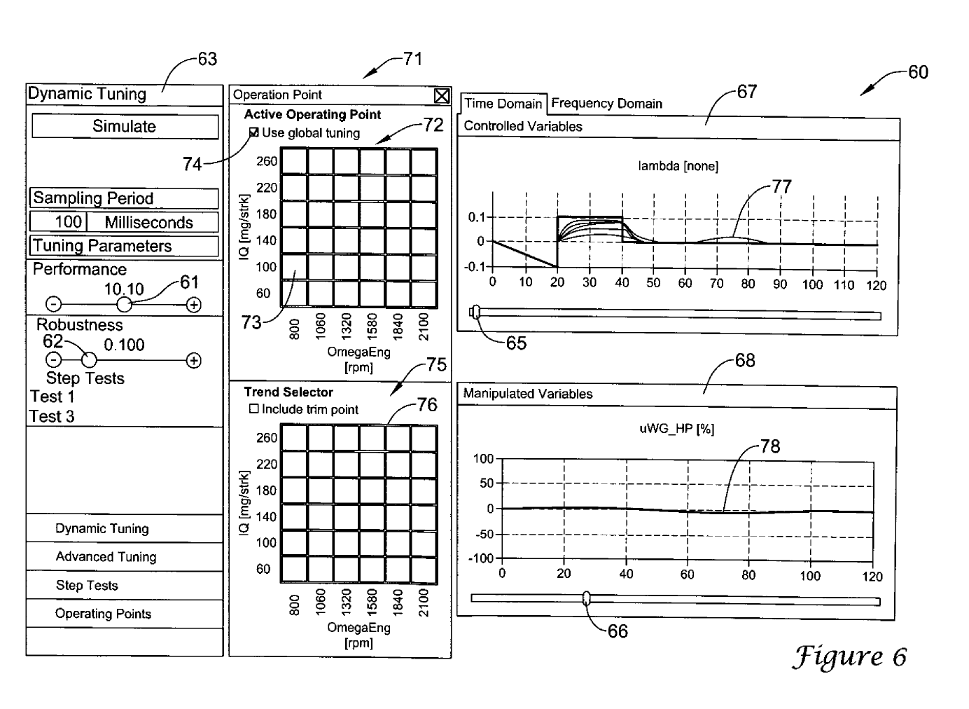

FIGS. 2a-2d may illustrate the 5-dimensional space visualization. FIG. 2a is a diagram 10 which may indicate an alternative placement of scheduled variables coordinates. The coordinates indicate position of operating point borders (edges), while showing positions of operating point centers. This may describe a variant for feedback which is not necessarily of FIG. 2a, but of FIG. 6. FIG. 2a may be used in a feed-forward controller design, where is important to show where feed-forward signal is calculated (operating point center). FIG. 2a may be used in feedback design, where is more useful to show where controller is switching from one tuning to another tuning—border between operating points.

Diagram 10 may be of an active operating point where global tuning is utilized. The diagram shows IQ [mg/strk] versus OmegaEng [rpm]. IQ [mg/strk] may be regarded as fuel injection quantity in milligrams per engine stroke at a given number of revs per minute of an engine.

A selected partition 11 may be inside a selected subspace. The partition may define a range where, for example, tuning parameters are valid. Partition 11 is not necessarily a point. The partition may be a multidimensional rectangular box. Partition 11 is shown situated at the 60 mg/strk and 800 rpm position of diagram 10.

FIG. 2b is a diagram 13 for a trend selector. Partition 11 may appear as a blue box or dark shade in the diagram. Rectangular boxes or partitions 14, 15, 16 and 17 may have various colors such as dark green, green, orange and red, respectively, or various distinguishing shades or symbols. There may be a multiple selection of partitions 14, 15, 16 and 17. The colors, shades or symbols of the partitions may mark a relationship of a trend among the partitions.

FIG. 2c is a diagram 19 of Pamb (ambient pressure) in kPa versus uSOI (start of injection). A selection may show an operating point. A rectangular box 21 may be one situated at Pamb of 100 kPa and 10 uSOI. Diagram 19 also shows a bar graph 22 which may reveal Tamb (ambient temperature) in C. degrees. A darkened box 23 may indicate an ambient temperature of 10 degrees C.

FIG. 2d is a diagram 25 of variables for the operating point selection. Diagram 25 which may indicate the X (OmegaEng) and Y (IQ) axes 26 and 27 of main grid 10 (FIG. 2a), X (uSOI) and Y (Pamb) axes 28 and 29 of grid 19 (FIG. 2c), and (Tamb) axis 31 of grid 22 (FIG. 2c). Diagram 25 may be regarded as indicating the axes of the five dimensions.

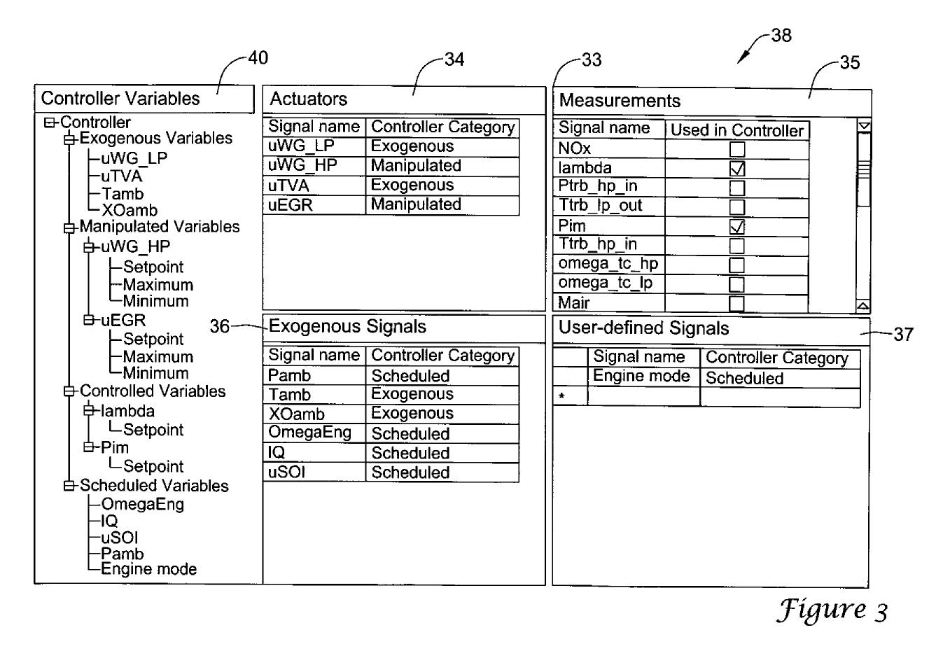

FIG. 3 is a diagram 38 of a controller configuration which is a basic screen for controller design. Users may map engine signals to controller variables on this screen.

Block 34 shows a list of actuators available on an engine. The list reveals a signal name and a controller category of each actuator, which may be listed respectively as uWG_LP and Exogenous, uWG_HP and Manipulated, uTVA and Exogenous, and uEGR and Manipulated. The user may say which actuator will be manipulated by the controller (i.e., manipulated variable) and which actuator will be measured only (i.e., exogenous variable).

Block 36 shows a list of exogenous signals. The list reveals a signal name and a controller category which may be listed respectively as Pamb and Scheduled, Tamb and Exogenous, XOamb and Exogenous, OmegaEng and Scheduled, IQ and Scheduled, and uSOI and Scheduled. Exogenous signals may be measured inputs to the engine, such as ambient pressure. The user may specify which signals are important for controller tuning (scheduled) and which signals do not affect controller tuning (i.e., an exogenous variable). The selected “scheduled” signals and their ranges may create engine operating space for which the controller will be design and tuned.

Block 35 shows a list of measurements. The list reveals a signal name and a check box whether it is used in the controller of which may be listed respectively as NOx and not checked, lambda and checked, Ptrb_hp_in and not checked, Ttrb_lp_out and not checked, Pim and checked, Ttrb_hp_in and not checked, omega_tc_hp and not checked, omega_tc_lp and not checked, Mair and not checked, and so on. The measurements may be measured signals, which can be controlled. The user may specify if a signal will be controlled (checked) or not (unchecked) as indicated herein.

Block 37 shows a list of one or more user-defined signals. The list reveals a signal name and a controller category, which may include Engine mode and scheduled, respectively. User-defined signals may be a list of signals which are not available on the engine, but can be used in the same way as an exogenous signal, for example, an engine mode—normal(0)/sport(1). User-defined signals may allow adding of additional dimensions to engine operating space and switch controller tuning in real-time, e.g., from tuning for normal mode to tuning for sport mode.

Also in diagram 38 is a tree-like hierarchy layout 40 of controller variables. Under the controller label may be exogenous variables, manipulated variables, controlled variables, and scheduled variables. Within exogenous variables may be items uWG_LP, uTVA, Tamb and XOamb. Within manipulated variables may be items uWG_HP and uEGR. Within uWG_HP may be indications of Setpoint, Maximum and Minimum. Within uEGR may be indications of Setpoint, Maximum and Minimum. Within controlled variables may be lambda and Pim with setpoint listed within lambda and Pim. Within scheduled variables may be OmegaEng, IQ, uSOI, Pamb and Engine mode.

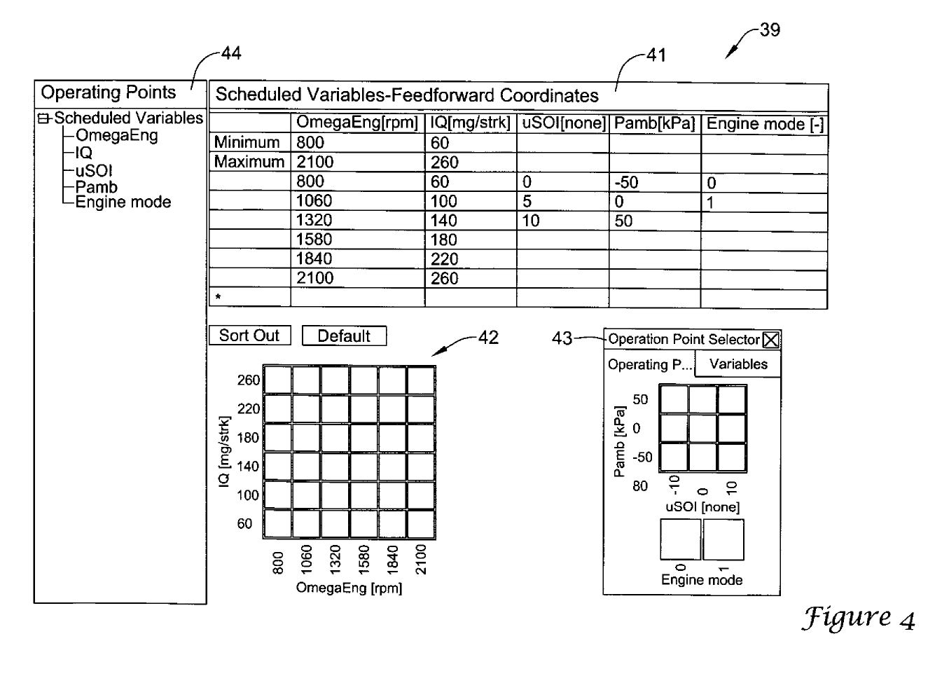

FIG. 4 is a diagram 39 of an operating point screen which may allow editing of coordinates of virtually all scheduled variables. The user may specify how the operating space will be partitioned. Entered coordinates may specify a central point of the operating partitions=operating points. In a tree-like listing 44, under the label “Scheduled Variables”, are listed OmegaEng, IQ, uSOI, Pamb and Engine mode. In a table 41, entitled “Scheduled Variables—Feedforward Coordinates”, the scheduled variables are headings from left to right across the top as OmegaEng [rpm], IQ [mg/strk], uSIO [none], Pamb [kPa] and Engine mode [—]. To the left in table 41, are listed Minimum and Maximum, which are indicated in the respective rows under OmegaEng [rpm] as 800 and 2100, respectively, and under IQ [mg/strk] as 60 and 260, respectively. Below these rows are readings for each of the scheduled variables noted in the headings.

Below table 41 is a block-like chart 42 of IQ [mg/strk] versus OmegaEng [rpm]. “Sort Out and “Default” blocks are shown above chart 42. To the right of table 41 is an operating point selection chart 43. The block-like chart may be of Pamb [kPa} versus uSOI [none]. Below the chart are engine mode blocks labeled 0 and 1.

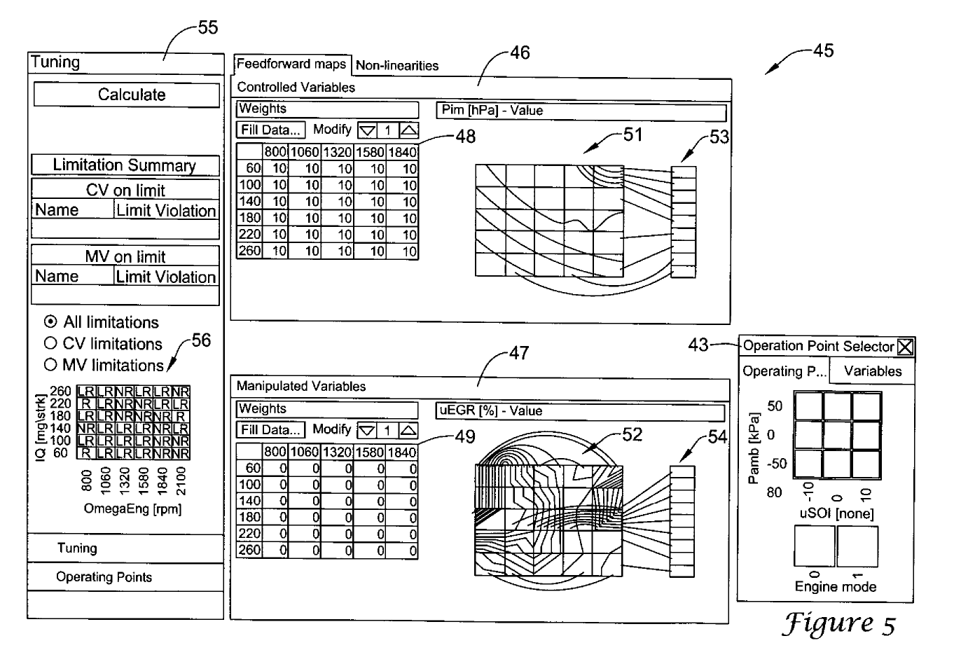

The controller may have two parts which are feedforward and feedback tuning. FIG. 5 is a diagram 45 which shows feedforward tuning. A user may enter weights for virtually all controlled variables in chart 46 and manipulated variables in chart 47 for virtually all operating points. For example, chart 46 shows a table 48 of OmegaEng [rpm] across the top and IQ [mg/strk] vertically at the left with the weights at the intersections of the top and left values for the controlled variables. For the other example, chart 47 shows a table 49 of OmegaEng [rpm] across the top and IQ [mg/strk] vertically at the left with the weights at the intersections of the top and left values for the manipulated variables.

Resulting feedforward values for an expected (modeled, simulated) controlled variable and a manipulated variable are visible in contour charts 51 and 52, respectively. The grids in the contour charts correspond to operating points. A user may select a controlled variable or manipulated variable by scrollbars on the right side. In chart 51, the value may be Pim [hPa]. In chart 52, the value may be uEGR [%]. Value ranges 53 in colors or shades may correspond to the shades or colors in chart 51. Since the colors may not necessarily be correlated or visible between chart 51 and ranges 53, lines may be drawn to connect the correlating values. Value ranges 54 in colors or shades may correspond to the shades or colors in chart 52. Since the colors may not necessarily be correlated or visible between chart 52 and ranges 54, lines may be drawn to connect the correlating values.

A tuning portion 55 of the left side of diagram 45 shows in which operating points are some manipulated variables or controlled variables or both on limit. In chart 56 of IQ [mg/strk], a red color intensity indicates how many variables are on a limit (and a lower number is indicated by a lighter red color). The red, lighter red and no red may be indicated by various shades or symbols such as R, LR or NR, respectively.

An operating point selector 43 shown to the right of chart 46 in diagram 45 is like the one in FIG. 4.

As noted herein, the controller has two parts, feedforward and feedback. A diagram 60 of FIG. 6 shows feedback tuning. Feedback controller tuning may be individual in each operating point. Or several operating points may share a common tuning (global tuning). Slider bars 61 and 62 on left side, “Performance” and “Robustness”, respectively, in a dynamic tuning portion 63, and slider bars 65 and 66 below charts 67 and 68, for controlled variables (e.g., lambda [none] and manipulated variables (e.g., uWG_HP [%]), respectively, may allow controller tuning.

An active operating point selector 71 in chart 72 (IQ [mg/strk] versus OmegaEng [rpm]) may show currently a selected operating point 73 and if the controller has individual tuning in this operating point 73 or it uses global tuning. Both current operating point 73 as well as global/individual tuning flag 74 may be modified.

A trend selector 75 may show a chart 76 (IQ [mg/strk] versus OmegaEng [rpm]) allow a selection of operating points. Controlled and manipulated variables may be displayed in the charts 67 and 68, respectively. Lines 77 and 78 for current (active) operating points are highlighted in graphs 67 and 68, respectively.

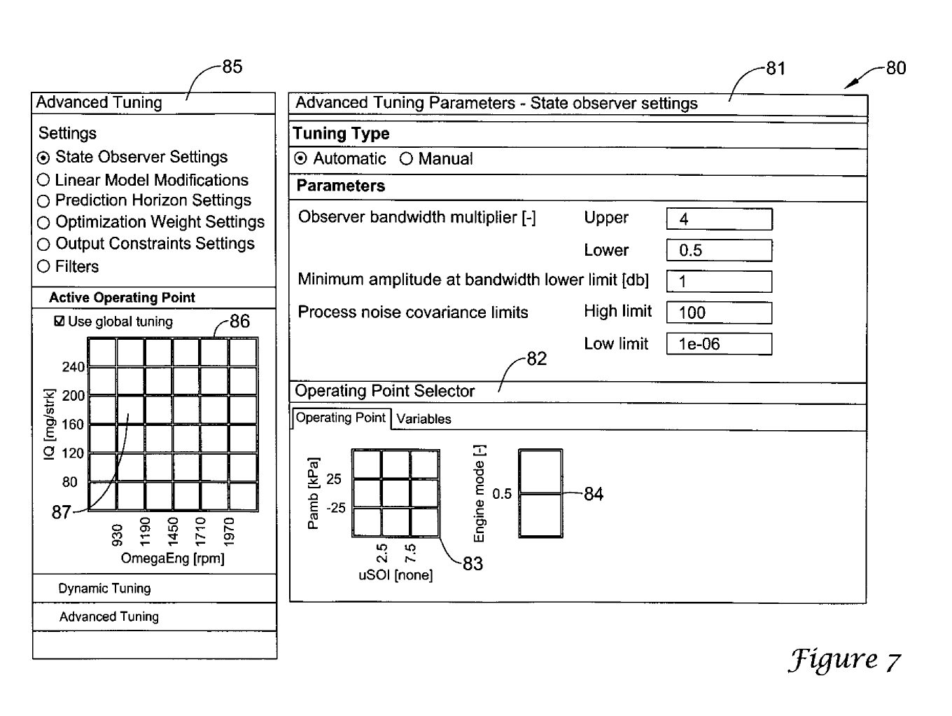

FIG. 7 is a diagram 80 revealing an example of feedback advanced tuning for a controller. Portion 81 of diagram 80 may show an instance of advanced tuning parameters and state observer settings. A selected tuning type may be automatic or manual. Parameters may include observer bandwidth multiplier. Portion 81 shows an upper number to be 4 and a lower number to be 0.5 for the multiplier. A minimum amplitude at bandwidth lower limit [dB] may be 1. Process noise covariance limits may have a high limit of 100 and a low limit of 1e-06. A lower potion 82 of diagram 80 may be an operating point selector showing a chart 83 of Pamb [kPa] versus uSOI [none]. An engine mode block chart 84 may be noted.

Diagram 80 may be similar to the previous diagram 60, but each group of parameters (settings) may have different global/individual tuning flag. For example, state observer settings in a current operating point may be shared with other operating points (global tuning), but prediction horizon settings for the same operating point may be individual for this operating point.

Portion 85 for advanced tuning of diagram 80 may show settings of which one, such as state observer settings, is selected. Other available setting may include linear model modifications, prediction horizon settings, optimization weight settings, output constraints setting and filters. An active operating point chart 86 (IQ [mg/strk] versus OmegaEng [rpm]) may be noted in FIG. 7. Block or square 87 may represent an active operating point.

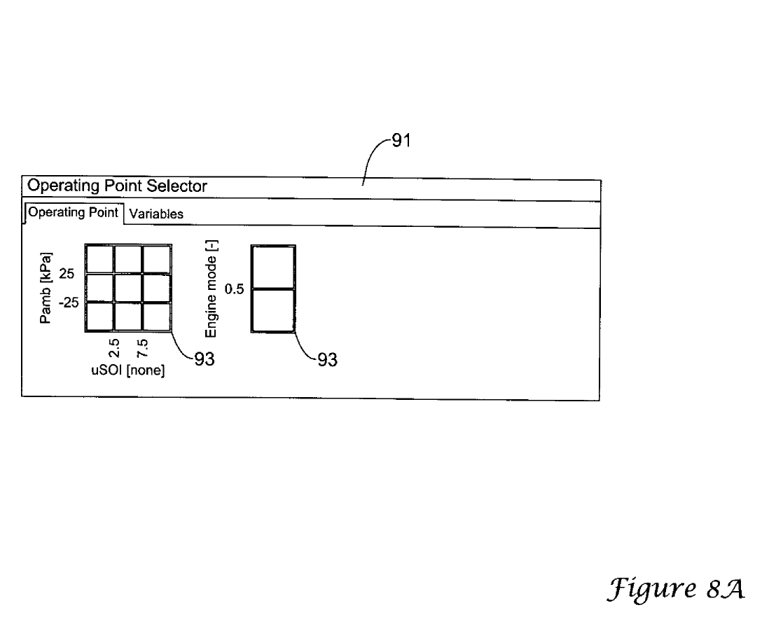

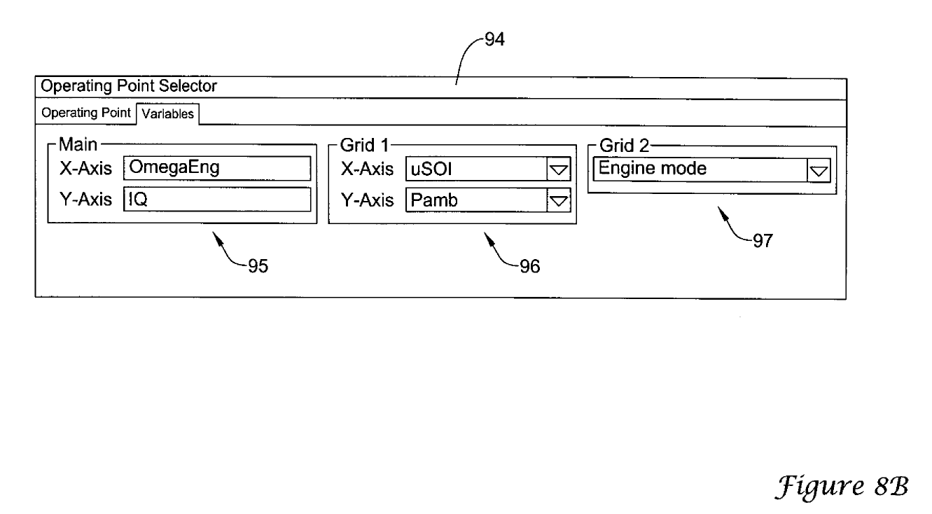

FIG. 8a is a diagram of an operating point selector 91 for an operating point. Selector 91 may have an example block chart 92 of Pamb [kPa] versus uSOI [none]. An engine mode chart 93 is also part of selector 91.

FIG. 8b is a diagram of an operating point selector 94 for variables. A main grid 95 may show OmegaEng for an X-axis and IQ for a Y-axis. A grid 96 may show uSOI for an X-axis and Pamb for a Y-axis. A grid 97 may show the Engine mode.

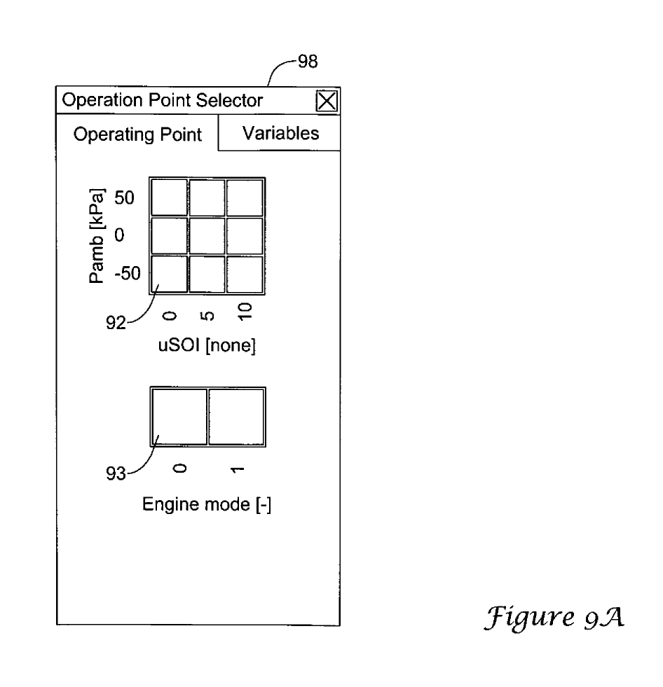

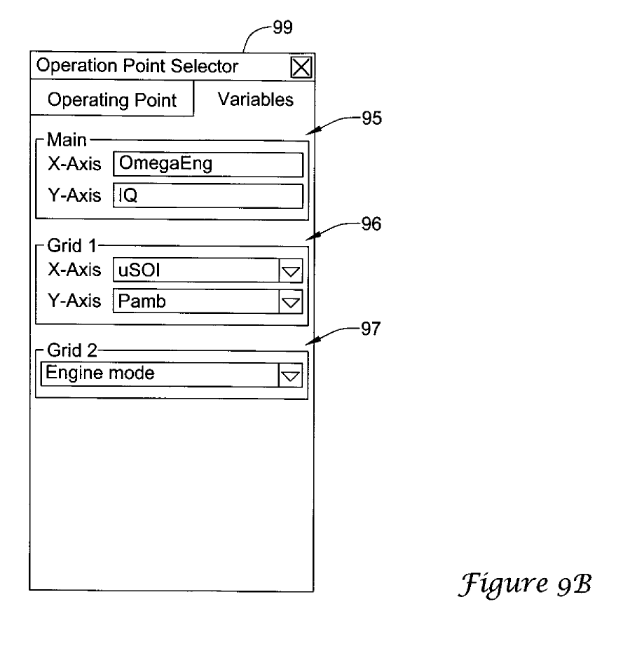

FIG. 9a is a diagram of an operating point selector 98 for an operating point. Selector 98 may have an example block chart 92 of Pamb [kPa] versus uSOI [none]. An engine mode chart 93 may also be part of selector 98.

FIG. 9b is a diagram of an operating point selector 99 for variables. A main grid 95 may show OmegaEng for an X-axis and IQ for a Y-axis. A grid 96 may show uSOI for an X-axis and Pamb for a Y-axis. A grid 97 may show the Engine mode.

FIG. 8a may be a horizontal version of the operating point selector for an operating point and FIG. 9a may be a vertical version of the operating point selector for an operating point. FIG. 8b may be a horizontal version of the operating point selector for variables and FIG. 9b may be a vertical version of the operating point selector for variables.

A recap in view of FIGS. 1-9b may be noted. An approach, for providing interactive visualization of partitions, may incorporate providing an engine model having operating points, a controller for interaction with the engine model, and a tuning of the controller for each of the operating points. The operating points may have a space. The space may define a matrix having a number of dimensions, and the number of dimensions may be similar to a number of scheduled variables.

The approach may also incorporate dividing each dimension of the number of dimensions into two or more intervals of scheduled variables, combining the two or more intervals to result in one or more multidimensional partitions, selecting one or more partitions, specifying tuning parameters for the one or more partitions, and providing graphical feedback about a tuning of the one or more parameters. The approach may further incorporate displaying each partition as a rectangular or other geometrically shaped cell. Each partition may have a tooltip for displaying information about the partition.

A system, for user interactive visualization, may incorporate a processor, a mechanical energy generator model, a sensor suite connected to the mechanical energy generator model and the processor, an actuator suite connected to the mechanical energy generator model and the processor, a display connected to the processor, and an interface connected to the processor. The display may provide a user interactive visualization of one or more operating points of the mechanical energy generator model.

The mechanical energy generator model may represent an internal combustion engine. The processor may provide a tuning for each one of the one or more operating points, and the one or more operating points may have a space. The space may define a multidimensional matrix. The multidimensional matrix may have a number of dimensions, and the number of dimensions may be similar to a number of scheduled variables. Each dimension of the number of dimensions may be divided into scheduled variable intervals. One or more combinations of the scheduled variable intervals may result in one or more multidimensional partitions.

A partition may be selected from the one or more multidimensional partitions, and the partition may be inside a selected subspace. The partition may define a range where tuning parameters are valid. A partition of the one or more multidimensional partitions may be shown on the display as a geometrically shaped cell. The cell may have properties of color, drawable text, and/or pressability. The properties may be used for selecting a partition related to interface elements and/or for showing on the display an abbreviated partition state.

Interface elements may incorporate tuning parameters, specifications, and/or trend lines. An abbreviated partition state may have a tuning type, a modified flag, and/or a valid flag. The cell may incorporate a tooltip for showing additional detailed information about the cell on the display.

A mechanism, for user interactive visualization of a multidimensional space of partitions, may incorporate an engine model having operating points, and an engine controller which provides tuning for the operating points. The operating points may have a space that defines a matrix having one or more dimensions. A number of the dimensions of the matrix may determine a number of scheduled variables.

Each dimension of the one or more dimensions may be divided into scheduled variable intervals. A combination of the scheduled variable intervals may result in one or more multi-dimensional partitions.

The mechanism may further incorporate a display connected to the engine controller. One or more partitions may be selected, and tuning parameters may be specified for the one or more partitions selected. Graphical feedback about a tuning of the one or more partitions selected may be presented on the display. Each partition selected may be presented on the display as a cell, and each cell may have a tooltip for presenting more extensive information about the cell on the display.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for providing interactive visualization of partitions, comprising:
providing an engine model, having operating points;
providing a controller for interaction with the engine model;
providing a tuning of the controller for each of the operating points; and
wherein:
the operating points have a space;
the space defines a matrix having a number of dimensions; and
the number of dimensions is a similar number of scheduled variables.

2. The method of claim 1, further comprising:
dividing each dimension of the number of dimensions into two or more intervals of scheduled variables; and
combining the two or more intervals to result in one or more multidimensional partitions.

3. The method of claim 2, further comprising:
selecting one or more partitions;
specifying tuning parameters for the one or more partitions; and
providing graphical feedback about a tuning of the one or more parameters.

4. The method of claim 2, further comprising:
displaying each partition as a cell having a geometrical shape; and
wherein each partition has a tooltip for displaying information about the partition.

5. A system for user interactive visualization, comprising:
a processor;
a mechanical energy generator model;
a sensor suite connected to the mechanical energy generator model and the processor;
an actuator suite connected to the mechanical energy generator model and the processor;
a display connected to the processor; and
an interface connected to the processor; and
wherein the display can provide a user interactive visualization of one or more operating points of the mechanical energy generator model.

6. The system of claim 5, wherein the mechanical energy generator model represents an internal combustion engine.

7. The system of claim 6, wherein the processor provides a tuning for each one of the one or more operating points.

8. The system of claim 7, wherein:
the one or more operating points comprise a space; and
the space defines a multidimensional matrix.

9. The system of claim 8, wherein:
the multidimensional matrix comprises a number of dimensions; and
the number of dimensions is similar to a number of scheduled variables.

10. The system of claim 9, wherein each dimension of the number of dimensions is divided into scheduled variable intervals.

11. The system of claim 10, wherein one or more combinations of the scheduled variable intervals result in one or more multidimensional partitions.

12. The system of claim 11, wherein:
a partition is selected from the one or more multidimensional partitions;
the partition is inside a selected subspace; and
the partition defines a range where tuning parameters are valid.

13. The system of claim 11, wherein:
a partition of the one or more multidimensional partitions is shown on the display as a geometrically shaped cell; and
the cell comprises properties of color, drawable text, and/or pressability.

14. The system of claim 13, wherein the properties are used for selecting a partition related to interface elements and/or for showing on the display an abbreviated partition state.

15. The system of claim 14, wherein:
interface elements comprise tuning parameters, specifications, and/or trend lines; and
an abbreviated partition state comprises a tuning type, a modified flag, and/or a valid flag.

16. The system of claim 13, wherein the cell comprises a tooltip for showing additional detailed information about the cell on the display.

17. A mechanism for user interactive visualization of a multidimensional space of partitions, comprising:
an engine model having operating points; and
an engine controller which provides tuning for the operating points; and
wherein:
the operating points have a space that defines a matrix having one or more dimensions; and
a number of the dimensions of the matrix determines a number of scheduled variables.

18. The mechanism of claim 17, wherein:
each dimension of the one or more dimensions is divided into scheduled variable intervals; and
a combination of the scheduled variable intervals results in one or more multi-dimensional partitions.

19. The mechanism of claim 18, further comprising:
a display connected to the engine controller; and
wherein:
one or more partitions are selected;
tuning parameters are specified for the one or more partitions selected; and
graphical feedback about a tuning of the one or more partitions selected is presented on the display.

20. The mechanism of claim 19, wherein:
each partition selected is presented on the display as a geometrical shaped cell; and
each cell has a tooltip for presenting more extensive information about the cell, on the display.
